(19) United States
(12) Patent Application Publication
(10) Pub. No.: US 2026/0093224 A1
(43) Pub. Date: Apr. 2, 2026

(54) SYSTEMS AND METHODS FOR CONTROLLING MULT-AGENT SYSTEMS

(71) Applicant: Sensia Netherlands B.V., Rotterdam (NL)

(72) Inventors: Aquib Mustafa, Houston, TX (US); Jonathan Wun Shiung Chong, Calgary (CA); Srikanth G. Mashetty, Houston, TX (US); Hugh Donohoe, Inverurie (GB); Martin Lenicky, Houston, TX (US)

(21) Appl. No.: 19/343,923

(22) Filed: Sep. 29, 2025

Related U.S. Application Data
(60) Provisional application No. 63/701,238, filed on Sep. 30, 2024.

(51) Int. Cl. G05B 19/042; G05B 19/418; G06F 18/21

(52) U.S. Cl. CPC G05B 19/0428; G05B 19/41855; G06F 18/2178

(57) ABSTRACT

A system includes industrial equipment providing operations of an oil-and-gas facility and a control system for the oil-and-gas facility. The control system includes a first edge agent configured to generate operational data associated with operation of the industrial equipment, a second edge agent configured to acquire the operational data from the first edge agent, and an oversight device. The second edge agent is configured to generate, based on the operational data, and provide control decisions to the industrial equipment. The oversight device is configured to acquire the operational data from the first edge agent, determine, based on the operational data, a validation score associated with the operational data, and responsive to the validation score being less than a validation threshold, prevent the second edge agent from acquiring the operational data.

### CROSS-REFERENCE TO RELATED PATENT APPLICATIONS

This application claims the benefit of and priority to Provisional Application U.S. Application 63/701238, filed Sep. 30, 2024, incorporated herein by reference in its entirety.

### BACKGROUND

The present disclosure relates to hydrocarbon sites. The present disclosure also relates to control systems for hydrocarbon sites including but not limited to control systems configured to assign scores to operational data corresponding to operations of industrial systems such as gas, geothermal, helium, and oil well sites, to determine accuracies and validities associated with the data.

### SUMMARY OF THE INVENTION

One implementation of the present disclosure is a system. The system includes industrial equipment providing operations of an oil-and-gas facility and a control system for the oil-and-gas facility. The control system includes a first edge agent configured to generate operational data associated with the operation of the industrial equipment, a second edge agent configured to acquire the operational data from the first edge agent, and an oversight device. The second edge agent is configured to generate, based on the operational data, and provide control decisions to the industrial equipment. The oversight device is configured to acquire the operational data from the first edge agent, determine, based on the operational data, a validation score associated with the operational data, and responsive to the validation score being less than a validation threshold, prevent the second edge agent from acquiring the operational data.

In some embodiments, the oversight device includes an oversight agent. In some embodiments, the oversight agent is executed in a cloud computing system. In some embodiments, the oversight agent is communicably coupled to each of the first edge agent and the second edge agent through a secure handshake. In some embodiments, the oversight device is configured to execute a complex validation model. In some embodiments, oversight device is configured to receive a confidence score from the first edge agent and assign the validation score using the confidence score. In some embodiments, the oversight device is configured to receive a first confidence score from the first edge agent and a second confidence score from the second edge agent and assign the validation score using the first confidence score and the second confidence score. In some embodiments, the oversight device is configured to receive a reputation score from the first edge agent and assign the validation score using the reputation score, wherein the reputation score represents a reputation associated with the first edge agent or data from the first edge agent.

In some embodiments, the oversight device is configured to acquire an uncertainty score associated with the operational data and responsive to the uncertainty score determining the validation score. In some embodiments, the oversight device is configured to acquire a reputation score associated with the operational data and responsive to the reputation score determine the validation score.

Some embodiments relate to a method of operating equipment providing operations of an oil or gas facility. The method includes generating operational data using a first edge agent associated with operation of the equipment, acquiring the operational data from the first edge agent by a second edge agent, and generating by the second edge agent, in response to the operational data, control decisions to the industrial equipment. The method also includes acquiring the operational data from the first edge agent by an oversight device, determining, based on the operational data, a validation score associated with the operational data using the oversight device, and responsive to the validation score being less than a validation threshold, preventing the second edge agent from acquiring the operational data.

In some embodiments, the oversight device comprises an oversight agent. In some embodiments, the oversight agent is executed in a cloud computing system. In some embodiments, the oversight agent is communicably coupled to each of the first edge agent and the second edge agent through a secure handshake. In some embodiments, the oversight device is configured to execute a complex validation model. In some embodiments, the oversight device is configured to receive a confidence score from the first edge agent and assign the validation score using the confidence score. In some embodiments, the oversight device is configured to receive a first confidence score from the first edge agent and a second confidence score from the second edge agent and assign the validation score using the first confidence score and the second confidence score.

Some embodiments relate to a system for equipment providing operations of an oil or gas facility. The system includes a first agent configured to generate operational data associated with operation of the equipment, a second agent configured to acquire the operational data from the first agent, the second agent configured to generate, based on the operational data, and provide control decisions to the equipment, and an oversight device. The oversight device is configured to acquire the operational data from the first agent, determine, based on the operational data, a validation score associated with the operational data, and responsive to the validation score being less than a validation threshold, prevent the second agent from acquiring the operational data.

In some embodiments, the oversight device is configured to receive a first confidence score from the first agent and a second confidence score from the second agent and assign the validation score using the first confidence score and the second confidence score. In some embodiments, the reputation score represents a reputation associated with the first agent or data from the first agent.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 illustrates a block diagram of a high-level overview of an industrial enterprise including a cloud-based computing system, according to some embodiments;

FIG. 2 illustrates a schematic diagram of an example hydrocarbon site that may produce and process hydrocarbons, according to some embodiments;

FIG. 3 illustrates a block diagram of a control system for controlling data flow between an oversight agent and edge agents of the example hydrocarbon site of FIG. 2, according to some embodiments.

FIG. 4 illustrates a flow diagram of a process for determining and displaying a confidence score associated with operational data, according to some embodiments;

FIG. 5 illustrates a flow diagram of a process for determining and displaying a reputation score associated with operational data, according to some embodiments; and

FIG. 6 illustrates a flow diagram of a process for determining and displaying a validation score associated with operational data, according to some embodiments.

### DETAILED DESCRIPTION

Before turning to the FIGURES, which illustrate certain exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

### Overview

Referring generally to the FIGURES, systems and methods for scoring operational data corresponding to operations of industrial equipment of an oil-and-gas facility are shown, according to some embodiments. In some embodiments, a control system is configured to score the operational data corresponding to the operations of the industrial equipment. The control system includes a plurality of edge agents (e.g., edge devices, etc.) associated with the industrial equipment and an oversight agent (e.g., an oversight device, etc.) communicably coupled to the edge agents. The edge agents are configured to generate the operational data corresponding to the operations of the industrial equipment. For example, the edge agents may be configured to receive sensor data from sensor units associated with the industrial equipment and generate the operational data based on the sensor data. The edge agents may utilize the operational data generated by the edge agents to determine control decisions associated with controlling the industrial equipment. For example, one of the edge agents may receive the operational data generated by other of the edge agents and utilize the operational data generated by the other of the edge agents to determine the control decisions associated with controlling of the industrial equipment. As a result, it may be advantageous to score the operational data in order identify faulty or corrupted operational data such that the edge agents may be made aware to not utilize the faulty or corrupted operational data when determining the control decisions associated with controlling the industrial equipment.

In some embodiments, the edge devices are configured to determine a confidence score associated with the operational data generated by the edge devices. The confidence score may represent an amount of uncertainty associated with the operational data generated by each of the edge devices. The edge devices may provide the confidence scores to the other of the edge devices and/or the oversight device while providing the operational data to the other of the edge devices and/or the oversight device such that the other of the edge devices and/or the oversight device are made aware of the uncertainty associated with the operational data and can take the uncertainty into account while generating control decisions. For example, the edge devices may weigh an effect of the operational data on the control decisions generated by the edge devices based on the confidence score associated with the operational data. The edge devices may increase an effect of the operational data on the control decisions generated by the edge devices when the confidence score associated with the operational data is high and may decrease an effect of the operational data on the control decisions generated by the edge devices when the confidence score associated with the operational data is low. As a result, an impact of uncertainty included in the operational data on the control decisions generated by the control system can be minimized.

In some embodiments, the edge devices are configured to determine a reputation score associated with the operational data received from other of the edge devices. The reputation score may represent reputation of the operational data received from the other of the edge devices. The edge devices may determine the reputation score based on comparing the operational data received form the other of the edge devices with the operational data generated by the edge devices. In some embodiments, the edge devices may determine the reputation score at least partially based on the confidence scores associated with the operational data received from the other of the edge devices. The edge devices may take the reputation score associated with the operational data into account while generating control decisions. For example, the edge devices may weigh an effect of the operational data on the control decisions generated by the edge devices based on the reputation score associated with the operational data. The edge devices may increase an effect of the operational data on the control decisions generated by the edge devices when the reputation score associated with the operational data is high and may decrease an effect of the operational data on the control decisions generated by the edge devices when the reputation score associated with the operational data is low. As a result, impact of corrupted and/or faulty operational data on the control decisions generated by the control system can be minimized.

In some embodiments, the oversight device is configured to determine a validation score associated with the operational data received from the edge devices. The validation score may represent a high-level reputation of the operational data received from the edge devices. For example, the oversight device may determine the validation scores associated with the operational data using data-based modeling that incorporates the operational data received from the edge devices. The control system may interrupt communication between the edge devices based on the validation scores. For example, if one of the edge devices is generating operational data with a validation score below a validation threshold, the control system may block communication between the one of the edge devices and other of the edge devices to prevent the operational data generated by the one of the edge devices from being used by the other of the edge devices to generate control decisions. As a result, the oversight device may be able to identify corrupted operational data that may not have been discovered by the edge devices while determining the confidence score or the reputation score, which may further minimize an impact of corrupted and/or faulty operational data on the control decisions generated by the control system.

### Hydrocarbon Site Overview

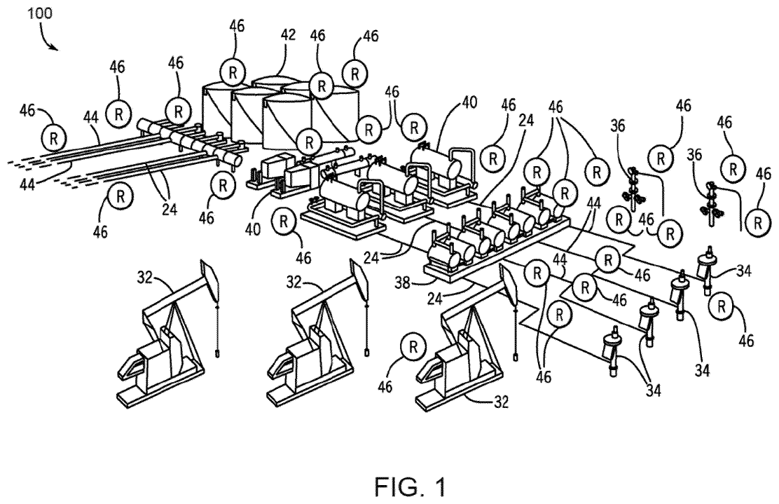

Referring now to FIG. 1, a hydrocarbon site 100 (e.g., an oil-and-gas facility) can be an area in which hydrocarbons, such as crude oil and natural gas, can be extracted from the ground, processed, and/or stored. As such, the hydrocarbon site 100 can include a number of wells and a number of well devices that can control the flow of hydrocarbons being extracted from the wells. In one embodiment, the well devices at the hydrocarbon site 100 can include any device equipped to monitor and/or control production of hydrocarbons at a well site. As such, the well devices can include pumpjacks 32, submersible pumps 34, well trees 36, and other devices for assisting the monitoring and flow of liquids or gasses, such as petroleum, natural gasses and other substances. After the hydrocarbons are extracted from the surface via the well devices, the extracted hydrocarbons can be distributed to other devices such as wellhead distribution manifolds 38, separators 40, storage tanks 42, and other devices for assisting the measuring, monitoring, separating, storage, and flow of liquids or gasses, such as petroleum, natural gasses and other substances. At the hydrocarbon site 100, the pumpjacks 32, submersible pumps 34, well trees 36, wellhead distribution manifolds 38, separators 40, and storage tanks 42 can be connected together via a network of pipelines 44. As such, hydrocarbons extracted from a reservoir can be transported to various locations at the hydrocarbon site 100 via the network of pipelines 44.

The pumpjack 32 can mechanically lift hydrocarbons (e.g., oil) out of a well when a bottom hole pressure of the well is not sufficient to extract the hydrocarbons to the surface. The submersible pump 34 can be an assembly that can be submerged in a hydrocarbon liquid that can be pumped. As such, the submersible pump 34 can include a hermetically sealed motor, such that liquids cannot penetrate the seal into the motor. Further, the hermetically sealed motor can push hydrocarbons from underground areas or the reservoir to the surface.

The well trees 36 or Christmas trees can be an assembly of valves, spools, and fittings used for natural flowing wells. As such, the well trees 36 can be used for an oil well, gas well, water injection well, water disposal well, gas injection well, condensate well, and the like. The wellhead distribution manifolds 38 can collect the hydrocarbons that can have been extracted by the pumpjacks 32, the submersible pumps 34, and the well trees 36, such that the collected hydrocarbons can be routed to various hydrocarbon processing or storage areas in the hydrocarbon site 100.

The separator 40 can include a pressure vessel that can separate well fluids produced from oil and gas wells into separate gas and liquid components. For example, the separator 40 can separate hydrocarbons extracted by the pumpjacks 32, the submersible pumps 34, or the well trees 36 into oil components, gas components, and water components. After the hydrocarbons have been separated, each separated component can be stored in a particular storage tank 42. The hydrocarbons stored in the storage tanks 42 can be transported via the pipelines 44 to transport vehicles, refineries, and the like.

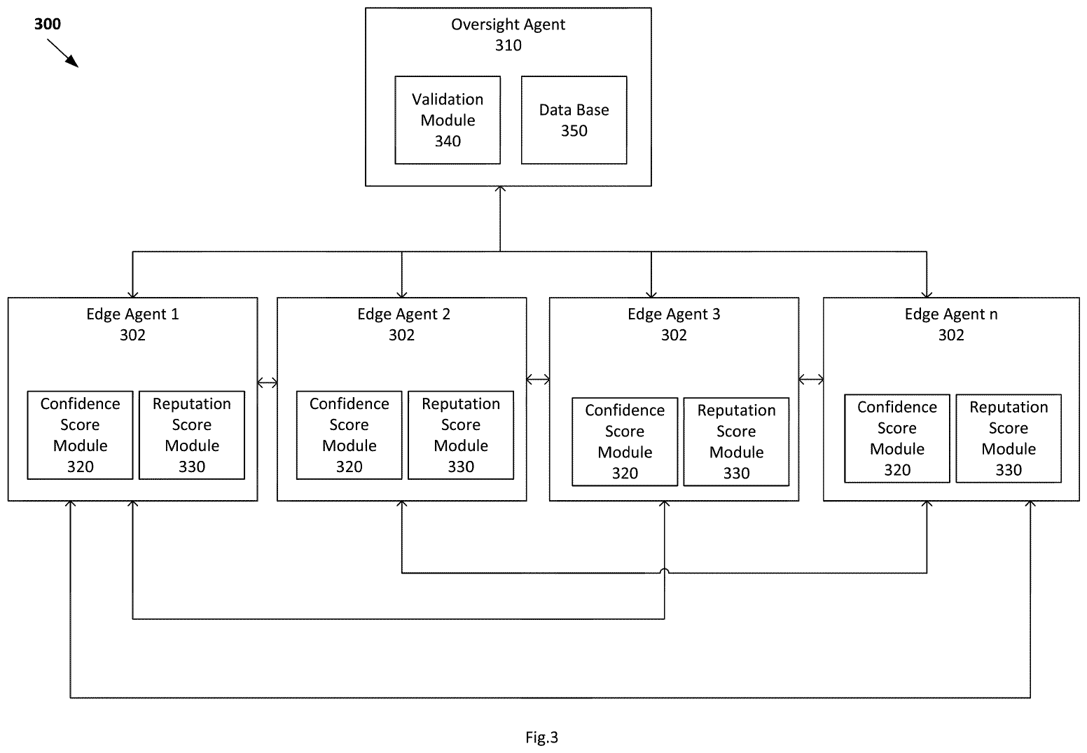

The well devices can also include monitoring systems that can be placed at various locations in the hydrocarbon site 100 to monitor or provide information related to certain aspects of the hydrocarbon site 100. As such, the monitoring system can be a controller, a remote terminal unit (RTU), or any computing device that can include communication abilities, processing abilities, and the like. For discussion purposes, the monitoring system will be embodied as the RTU 46 throughout the present disclosure. However, it should be understood that the RTU 46 can be any component capable of monitoring and/or controlling various components at the hydrocarbon site 100. The RTU 46 can include sensors or can be coupled to various sensors that can monitor various properties associated with a component at the hydrocarbon site 100. In some embodiments, one or more of the RTUs 46 of FIG. 1 are configured as one or more edge agents 302 as shown in FIG. 3 and described below.

The RTU 46 can then analyze the various properties associated with the component and can control various operational parameters of the component. For example, the RTU 46 can measure a pressure or a differential pressure of a well or a component (e.g., storage tank 42) in the hydrocarbon site 100. The RTU 46 can also measure a temperature of contents stored inside a component in the hydrocarbon site 100, an amount of hydrocarbons being processed or extracted by components in the hydrocarbon site 100, and the like. The RTU 46 can also measure a level or amount of hydrocarbons stored in a component, such as the storage tank 42. In certain embodiments, the RTU 46 can be iSens-GP Pressure Transmitter, iSens-DP Differential Pressure Transmitter, iSens-MV Multivariable Transmitter, iSens-T2 Temperature Transmitter, iSens-L Level Transmitter, or Isens-1O Flexible 1/0 Transmitter manufactured by vMonitor® of Houston, Texas.

In one embodiment, the RTU 46 can include a sensor that can measure pressure, temperature, fill level, flow rates, and the like. The RTU 46 can also include a transmitter, such as a radio wave transmitter, which can transmit data acquired by the sensor via an antenna or the like. The sensor in the RTU 46 can be wireless sensors that can be capable of receive and sending data signals between RTUs 26. To power the sensors and the transmitters, the RTU 46 can include a battery or can be coupled to a continuous power supply. Since the RTU 46 can be installed in harsh outdoor and/or explosion-hazardous environments, the RTU 46 can be enclosed in an explosion-proof container that can meet certain standards established by the National Electrical Manufacturer Association (NEMA) and the like, such as a NEMA 4X container, a NEMA 7X container, and the like.

The RTU 46 can transmit data acquired by the sensor or data processed by a processor to other monitoring systems, a router device, a supervisory control and data acquisition (SCADA) device, or the like. As such, the RTU 46 can enable users to monitor various properties of various components in the hydrocarbon site 100 without being physically located near the corresponding components. The RTU 46 can be configured to communicate with the devices at the hydrocarbon site 100 as well as mobile computing devices via various networking protocols.

In operation, the RTU 46 can receive real-time or near real-time data associated with a well device. The data can include, for example, tubing head pressure, tubing head temperature, case head pressure, flowline pressure, wellhead pressure, wellhead temperature, and the like. In any case, the RTU 46 can analyze the real-time data with respect to static data that can be stored in a memory of the RTU 46. The static data can include a well depth, a tubing length, a tubing size, a choke size, a reservoir pressure, a bottom hole temperature, well test data, fluid properties of the hydrocarbons being extracted, and the like. The RTU 46 can also analyze the real-time data with respect to other data acquired by various types of instruments (e.g., water cut meter, multiphase meter) to determine an inflow performance relationship (IPR) curve, a desired operating point for the well device, key performance indicators (KPis) associated with the well device, wellhead performance summary reports, and the like. Although the RTU 46 can be capable of performing the above-referenced analyses, the RTU 46 cannot be capable of performing the analyses in a timely manner. Moreover, by just relying on the processor capabilities of the RTU 46, the RTU 46 is limited in the amount and types of analyses that it can perform. Moreover, since the RTU 46 can be limited in size, the data storage abilities can also be limited.

In certain embodiments, the RTU 46 can establish a communication link with the cloud-based computing system 12 described above. As such, the cloud-based computing system 12 can use its larger processing capabilities to analyze data acquired by multiple RTUs 26. Moreover, the cloud-based computing system 12 can access historical data associated with the respective RTU 46, data associated with well devices associated with the respective RTU 46, data associated with the hydrocarbon site 100 associated with the respective RTU 46 and the like to further analyze the data acquired by the RTU 46. The cloud-based computing system 12 is in communication with the RTU via one or more servers or networks (e.g., the Internet).

In some embodiments, the best operating point of a submersible downhole pump can be determined by performing an optimization process. For example, model-based optimization or artificial intelligence can be used in order to determine an operating point (i.e., operating pressure, flow, and/or speed of the pump). In some embodiments, the optimization process can include determining the set of wells and the corresponding pump operating points in order to hit a certain production constraint while operating efficiently. In some embodiments, the best operating point can be transmitted to a motor optimization system.

### Site Control System

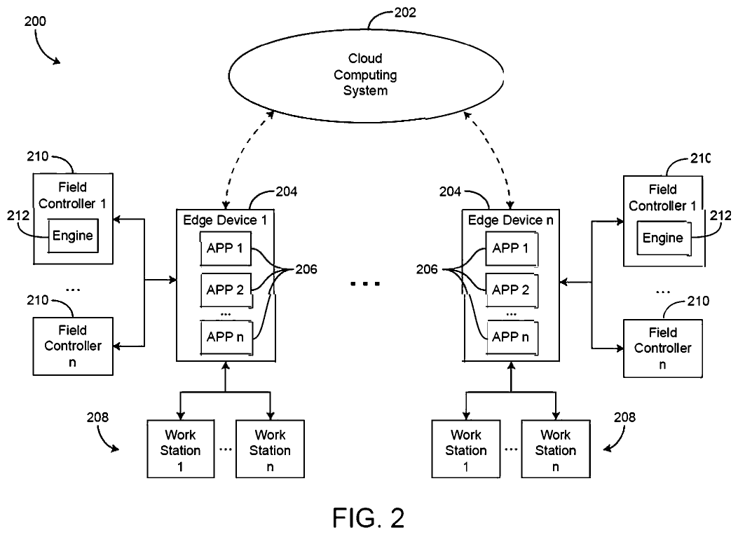

Referring particularly to FIG. 2, control system 200 for hydrocarbon site 100 is shown, according to some embodiments. In some embodiments, control system 200 includes or is configured to communicate with cloud computing system 202 and is configured to control various operations of a well site (e.g., hydrocarbon site 100, oil-and-gas facility) based on analyzing metadata from various devices within control system 200. Cloud computing system 202 may include any processing circuitry, processors, memory, etc., or combination thereof that are positioned remotely from hydrocarbon site 100. In various embodiments, some or all of the processing circuity, processors, memory, etc., or combination thereof within cloud computing system 202 may be performed by various devices disclosed within control system 200. Control system 200 is further shown to include edge devices 204, and workstations 208, and field controllers 210. Edge device (n) 204, workstation (n) 208, and field controller (n) 210 as seen in FIG. 2 indicate any number of the edge device 204, workstation 208, and field controller 210 can be implemented in the control system 200.

While cloud computing system 202 is generally disclosed herein as performing some or all of the functionality of the methods disclosed herein, cloud-based architecture (e.g., cloud computing system 202 connected to edge device(s) 204 and field controller 210, etc.) is purely an exemplary embodiment and is not intended to be limiting. In some embodiments, the methods disclosed herein may be implemented by systems that do not include or utilize a cloud-based computing system (e.g., cloud computing system 202). In some embodiments, the systems and methods disclosed herein are architecture agnostic, such that they may be implemented across a variety of architectures including private or on-premise server infrastructure.

The edge devices 204 may be configured to run, perform, implement, store, etc., one or more applications 206 thereof. Application (n) 206 indicates any number of the application 206 can be run on the edge devices 204. Additionally, some or all processing circuity, processors, memory, etc. included in various devices within control system 200 (e.g., edge device 204, field controller 210, workstation 208, etc.) may be distributed across several other devices within control system 200 or integrated into a single device. Edge device(s) 204 may be configured to receive data from field controller(s) 210 and provide data analytics to cloud computing system 202 based on the received data. This is described in greater detail below with reference to FIG. 3.

In some embodiments, each edge device 204 includes a processing circuit having a processor and memory. The processor can be a general purpose or specific purpose processor, an application specific integrated circuit (ASIC), one or more field programmable gate arrays (FPGAs), a group of processing components, or other suitable processing components. The processor is configured to execute computer code or instructions stored in the memory or received from other computer readable media (e.g., CDROM, removable USB drive, network storage, a remote server, etc.), according to some embodiments.

In some embodiments, the memory can include one or more devices (e.g., memory units, memory devices, storage devices, etc.) for storing data and/or computer code for completing and/or facilitating the various processes described in the present disclosure. The memory can include random access memory (RAM), read-only memory (ROM), hard drive storage, temporary storage, non-volatile memory, flash memory, optical memory, or any other suitable memory for storing software objects and/or computer instructions. The memory can include database components, object code components, script components, or any other type of information structure for supporting the various activities and information structures described in the present disclosure. The memory can be communicably connected to the processor via the processing circuitry and can include computer code for executing (e.g., by the processor) one or more processes described herein.

In some embodiments, various edge device(s) 204 may include some or all functionality of remote terminal units (RTUs) (e.g., RTU 46). In various embodiments, edge device(s) 204 is not limited to the functionality of RTU's and can include other controller features. Similarly, RTU's, as described herein, may refer to any industrial edge controller which is programmable and/or capable of one or more applications, either individually or as a module within a broader system (e.g., control system 200).

Field controllers 210 may be configured to control various operations at a well site and are communicably coupled with edge devices 204. In some embodiments, field controllers 210 are configured to operate (e.g., provide control signals to, provide setpoints to adjust setpoints or operational parameters thereof) field equipment (e.g., electric submersible pumps (ESPs), cranes, pumps, etc.) of hydrocarbon site 100. Field controllers 210 may be grouped into different sets based on which edge device 204 field controller 210 communicate with. In some embodiments, edge device(s) 204 are configured to exchange any sensor data, measurement data, meter data (e.g., flow meter data), storage data, maintenance data, control signals, setpoint adjustments, operational adjustments, diagnostic data, analytics data, meta data, etc., with field controllers 210. It should be understood that each edge device 204 can be associated with, corresponding to, etc., multiple field controllers 210.

In some embodiments, one or more of field controllers 210 can include a computing engine 212. Computing engine 212 can be configured to perform various control, diagnostic, analytic, reporting, meta data-related, etc., functions. Computing engine 212 can be embedded in one or more of field controller 210 or may be embedded at one or more of edge devices 204. In some embodiments, any of the functionality of computing engine 212 is distributed across multiple of the edge devices 204 and/or multiple field controllers 210. In some embodiments, any of the functionality of computing engine 212 is performed by cloud computing system 202.

Still referring to FIG. 2, workstations 208 may be configured to receive user instructions for controlling hydrocarbon site 100 and provide control signals to various devices via control system 200. Workstations 208 can include any desktop computer, laptop computer, personal computer device, user interface, personal computer device, etc., or any general computing device thereof. In some embodiments, multiple workstations 208 (e.g., an n number of workstations 208) are associated with each edge device 204, while in other embodiments, one or more of edge devices 204 are associated with a single workstation 208.

In some embodiments, field controller(s) 210 may be configured to act as edge devices such that field controller(s) 210 perform additional processing (e.g., data analysis, mapping, etc.) prior to providing information to cloud computing system 202. In some embodiments, this decreases latency in information processing to cloud computing system 202. In other embodiments, edge device(s) 204 operate as traditional edge devices and perform significant storage and processing within control system 200 (e.g., on-site, at/near hydrocarbon site 100, etc.) to mitigate latency due to processing information in cloud computing system 202.

### Data Scoring System

Referring now to FIG. 3, a control system 300 for scoring operational data associated with agents (e.g., control devices, etc.) of the hydrocarbon site 100 is shown, according to some embodiments. The control system 300 includes a number of edge agents 302 and an oversight agent 304 communicably coupled to each of the edge agents 302. In some embodiments, the oversight agent 310 is communicably coupled to each of the edge agents 302 through a secure “handshake.” For example, the oversight agent 310 may follow a security protocol while providing data to and/or receiving data from the edge agents 302. Edge agents (n) 302 as seen in FIG. 3 indicate any number of the edge agents 302 can be implemented in the control system 300. Each of the edge agents 302 are communicably coupled to at least one other of the edge devices 204. According to the exemplary embodiment shown in FIG. 3, each of the edge agents 302 are communicably coupled to each of the other of the edge agents 302. In other embodiments, each of the edge agents 302 are communicably coupled to adjacent of the other of the edge agents 302. For example, a first of the edge agents 302 may be associated with a first pump, a second of the edge agents 302 may be associated with a second pump positioned downstream of the first pump, and a third of the edge agents 302 may be associated with a third pump positioned downstream of the first pump and the second pump. The second of the edge agents 302 may be communicably coupled with the first of the edge agents 302 and the third of the edge agents 302, but the first of the edge agents 302 may not be communicably coupled to the third of the edge agents 302. In some embodiments, the edge agents 302 are communicably coupled to the other of the edge agents 302 through a secure “handshake.” In some embodiments, the systems and methods disclosed herein are architecture agnostic, such that they may be implemented across a variety of architectures including private or on-premise server infrastructure.

The edge agents 302 and/or the oversight agent 310 can be configured to monitor, control, and improve functionality of the edge device 204. The edge agents 302 and/or the oversight agent 310 can utilize an enterprise data management (EDM) with industrial internet of things (IIoT) framework to operate the edge device 204, operate the field controllers 210, control the computing engines 212, etc. The edge agents 302 and/or the oversight agent 310 can include one or more processors and one or more non-transitory computer-readable medium storing program instructions to be executed by the one or more processors to provide the operations attributed to the edge agents 302 and/or the oversight agent 310 or its components herein. For example, the edge agents 302 can receive and combine sensor data received from various of the field controllers 210 and assign a confidence score (e.g., a confidence, a confidence benchmark, etc.) to the combined sensor data based on uncertainty associated with the senor data and/or the field controllers 210. As another example, the oversight agent 310 may receive data and confidence scores associated with the data from the edge agents 302 and perform analysis on the data and confidence scores to validate or reject the data and the confidence scores. Various functions described with reference to the components of the edge agents 302 and/or the oversight agent 310 described further herein can be performed in various orders and/or combined or moved to other components of the control system 300.

Each of the edge agents 302 are configured to generate and provide operational data to other components (e.g., other of the edge agents 302, the oversight agent 310, etc.) of the control system 300. For example, a first of the edge agents 302 may receive sensor data associated with an operation of a well device (e.g., from one of the field controllers 210, etc.), generate operational data associated with the operation of the well device based on the sensor data, and provide the operational data to at least one other of the edge agents 302 of the control system 300. Each of the edge agents 302 may utilize the operational data received from the other of the edge agents 302 to generate control signals to control various operations at the hydrocarbon site 100. For example, a first of the edge agents 302 may be associated with a first pump of the hydrocarbon site 100 and a second of the edge agents 302 may be associated with a second pump of the hydrocarbon site 100 positioned downstream of the first pump. The second of the edge agents 302 may receive operational data from the first of the edge agents 302 corresponding to the operation of the first pump (e.g., based on sensor data corresponding to the operation of the first pump, etc.). The second of the edge agents 302 may generate control signals for the second pump based on the operational data corresponding to the first pump. For example, if the first pump is being operated (e.g., being operated by the first of the edge agents 302, etc.) at a first flow rate, the second of the edge agents 302 may generate control signals to operate the second of the pumps at the first flow rate so that a head pressure of the second pump is not increased or decreased. As another example, if a first of the edge agents 302 is associated with the pumpjack 32 and a second of the edge agents 302 is associated with the separator 40, the second of the edge agents 302 may receive operational data from the first of the edge agents 302 corresponding to operation of the pumpjack 32 (e.g., based on sensor data corresponding to the operation of the pumpjack 32. The second of the edge agents 302 may generate control signals for the separator 40 based on the operational data corresponding to the operation of the pumpjack 32. For example, if the operational data corresponding to the pumpjack 32 indicates that a temperature of hydrocarbons pumped by the pumpjack 32 increases from a first temperature to a second temperature, the second of the edge agents 302 may operate the separator 40 to increase a flow of coolant through the separator 40 to account for the increase in temperature of the hydrocarbons that will be supplied from the pumpjack 32 to the separator 40.

In some embodiments, each of the edge agents 302 include some or all of the functionality of the edge devices 204 and/or the RTUs 46. For example, the edge agents 302 may each be configured as one of the edge devices 204. For example, the edge agents 302 may receive sensor data from the field controllers 210 associated with operations of well devices of the hydrocarbon system or site 100. In various embodiments, the edge agents 302 are not limited to the functionality of RTUs 46 and can include other controller features. Similarly, RTUs, as described herein, may refer to any industrial edge controller which is programmable and/or capable of one or more applications, either individually or as a module within a broader system (e.g., control system 300).

In some embodiments, the oversight agent 304 includes some or all of the functionality of the edge devices 204. For example, the edge agents 302 may each be configured as one of the edge devices 204 and the oversight agent 304 may be configured as another of the edge devices 204 that is communicably coupled to the edge agents 302. As another example, the edge agents 302 may each be configured as one of the field controllers 210 and the oversight agent 310 may be configured as the edge devices 204 that is communicably coupled to teach of the edge agents 302. In some embodiments, the oversight agent 304 is included in at least one of the edge agents 302. For example, at least one of the edge agents 302 may perform both the functionality described herein regarding the edge agents 302 and the functionality described herein regarding the oversight agent 304. In various embodiments, the oversight agent 304 is not limited to the functionality of edge devices 204 and can include other controller features. For example, the oversight agent 310 can both control equipment (e.g., via the controller portion, etc.) and validate data received from the edge agents 302 by performing analysis on the data received from the edge agents 302.

The oversight agent 310 can be, for example, a HCC2 controller manufactured by Sensia LLC in some embodiments. The HCC2 controller can include analog acquisition hardware and software. In some embodiments, the oversight agent 310 includes wired or wireless communication interfaces (e.g., jacks, antennas, transmitters, receivers, transceivers, transmitters, wire terminals, etc.) for conducting data communications with various of the edge agents 302 and/or cloud computing system 202. For example, the oversight agent 310 can include a Wi-Fi transceiver, cellular, or mobile phone communication transceivers for communication via wireless communication network. By configuring the oversight agent 310 as one of the edge devices 204 instead of performing the functionality of the oversight agent 310 in the cloud, latency can be decreased compared to sending the data to the cloud computing system 202 for processing. For example, providing one of the edge devices 204 with the functionality of the oversight device may allow for improved data analytics and control schema without significantly increasing processing latency.

In other embodiments, the oversight agent 304 includes some or all of the functionality of the cloud computing system 202. For example, the edge agents 302 may each be configured as one of the edge devices 204 and the oversight agent 310 may be configured as the cloud computing system 202 that is communicably coupled to each of the edge agents 302. By configuring the oversight agent 310 as the cloud computing system 202, the score validation performed by the oversight agent 310 may be performed by the cloud computing system 202 that may have higher processing power than the edge devices 204, increasing a speed at which the scores associated with the edge agents 302 can be validated.

As shown in FIG. 3, the edge agents 302 are configured to run, perform, implement, store, etc., a confidence score module 320 configured to generate a confidence score (e.g., a confidence, a confidence state score, etc.) associated with operational data provided by the edge agents 302 (e.g., a confidence score associated with the edge agents 302, etc.) to other components of the control system 300 (e.g., other of the edge agents 302, etc.). For example, one of the edge agents 302 may be associated with the well tree 36 and may generate operational data corresponding to the operation of the well tree 36 (e.g., based on sensor data corresponding to the operation of the well tree 36, etc.). The edge agent 302 may utilize the confidence score module 320 to generate a confidence score associated with the operational data. The confidence scores may be associated with an amount of confidence that the edge agents 302 has in the operational data associated generated by the edge agents 302. The confidence score module 320 may determine the confidence score based on an amount of uncertainty associated with the sensor data received by the edge agents 302, a confidence factor associated with the edge agents 302, and/or a confidence model of the confidence score module 320. Advantageously, the confidence score determined by the confidence score module 320 can allow for the control system 300 to weigh an effect of the operational data generated by each of the edge agents 302 on the control signals generated by the edge agents 302. For example, a first of the edge agents 302 may generate control signals for a well device based on first operational data received from a second of the edge agents 302 and second operational data received from a third of the edge agents 302. The first of the edge agents 302 may increase a weight of the effect of the first operational data on the control signals for the well device if a first confidence score associated with the first operational data being higher than a second confidence score associated with the second operational data. In some embodiments, the oversight agent 310 is configured to run, perform, implement, store, etc., the confidence score module 320.

In some embodiments, the confidence score module 320 is configured to determine the confidence score associated with the operational data generated by the edge agent 302 based on an uncertainty associated with the sensor data received by the edge agent 302. The confidence score module 320 may determine the uncertainty associated with the sensor data received by the edge agent 302 based on international guidelines and standards on the expression of uncertainty in measurements. In some embodiments, the confidence score module 320 complies to JCGM 100:2008 GUM. For example, the uncertainty associated with the sensor data may be based on an accuracy of the sensors that generated the sensor data (e.g., based on calibration errors, based on a time since last calibration, based on a projected drift of the sensors, etc.), based on a precision associated with the sensor data (e.g., noise in the sensor data, random errors in the sensor data, etc.), a resolution associated with the sensor data (e.g., a granularity of the sensor data, etc.), environmental conditions associated with the sensor data, a sampling rate associated with the sensor data, errors introduced when processing the sensor data, and/or any other components that may impact uncertainty associated with sensor data.

In some embodiments, the confidence score module 320 is configured to determine the confidence score associated with the operational data generated by the edge agent 302 based on a sample size of the operational data. For example, the confidence score module 320 may determine that the confidence score associated with the operational data is higher when the sensor data utilized by the edge agent 302 to generate the operational data encompasses a greater sample size of data than when the sensor data encompasses a smaller sample size of data. As another example, the confidence score module 320 may determine that a first confidence score associated with first operational data generated by the edge agent 302 based on first sensor data obtained over a first time frame is higher than a second confidence score associated with second operational data generated by the edge agent 302 based on second sensor data obtained over a second time frame when the first time frame is longer than the second time frame.

In some embodiments, the confidence score module 320 is configured to determine the confidence score associated with the operational data generated by the edge agent 302 based on a complexity of the process utilized by the edge agent 302 to generate the operational data. For example, the confidence score module 320 may determine that a first confidence score associated with first operational data generated by the edge agent 302 using a first model with a first complexity is higher than a second confidence score associated with second operational data generated by the edge agent 302 using a second model with a second complexity that is less complex than the first complexity (e.g., the first model uses less processing power than the second model, the first model requires less assumptions than the second model, etc.). As another example, the confidence score module 320 may determine that a first confidence score associated with first operational data generated by the edge agent 302 based on first sensor data obtained from a first sensor is higher than a second confidence score associated with second operational data generated by the edge agent 302 based on second sensor data obtained from a second sensor based on the second sensor being more complex than the first sensor (e.g., the first sensor takes a direct reading and the second sensor takes a tangential reading, etc.).

In some embodiments, the confidence score module 320 is configured to determine the confidence score associated with the operational data generated by the edge agent 302 based on variance in the operational data. For example, the confidence score module 320 may determine that a first confidence score associated with first operational data is higher than a second confidence score associated with second operational data based on the first operational data varying less than the second operational data (e.g., a first rate of change of the first operational data is less than a second rate of change of the second operational data, an first amplitude of change of the first operational data is less than a second amplitude of change of the second operational data, etc.). As another example, the confidence score module 320 may determine that a well device associated with one of the edge agents 302 is operating under a comprised or faulty scenario based on a rate of change of an output signal and/or a rate of change of the input signal of the well device and assign the operational data generated by the one of the edge agents 302 a low confidence score accordingly. The comprised or faulty scenario may additionally or alternatively be indicated based on the operational data hitting constraint boundaries associated with the operational data at a frequency that is greater than a boundary frequency threshold.

In some embodiments, the confidence score module 320 is configured to determine the confidence score associated with the operational data generated by the edge agent 302 based on the operational data received by the edge agent 302 from another of the edge agents 302 of the control system 300. The confidence score module 320 may utilize a data-driven model to analyze the operational data generated by the edge agent 302 and the operational data received by the edge agent 302 from the other of the edge agents 302 to determine the confidence score. For example, a first of the edge agents 302 may generate first operational data associated with a first well device. The first of the edge agents 302 may receive second operational data associated with a second well device positioned upstream of the first well device from a second of the edge agents 302. The first of the edge agents 302 utilize the confidence score module 320 to generate a first confidence score corresponding to the first operational data based on a comparison of the first operational data and the second operational data. For example, if the first operational data and the second operational data correspond to a flow rate of a fluid that flows through both the first well device and the second well device, the confidence score module 320 may determine the first confidence score based on a difference between the first operational data and the second operational data regarding the flow rate. The confidence score module 320 may assign a higher confidence score to the first operational data if a first value of the flow rate included in the first operational data is closer to a second value of the flow rate included in the second operational data than if the first value of the flow rate is further than the second value of the flow rate.

In some embodiments, the confidence score module 320 is configured to determine the confidence score associated with the operational data generated by the edge agent 302 based on the confidence score received by the edge agent 302 from another of the edge agents 302 corresponding to the operational data generated by the other of the edge agent 302. For example, a first of the edge agents 302 may generate first operational data associated with a first well device. The first of the edge agents 302 may receive second operational data associated with a second well device positioned upstream of the first well device and a second confidence score associated with the second operational data from a second of the edge agents 302. The first of the edge agents 302 may provide the first operational data, the second operational data, and the second confidence score to the confidence score module of the first of the edge agents 302 and the confidence score module 320 may generate a first confidence score associated with the first operational data based on a comparison of the first operational data and the second operational data, weighed by the second comparison score. For example, if the first operational data and the second operational data correspond to a viscosity of a fluid that flows through both the first well device and the second device, the confidence score module 320 may determine the first confidence score based on a difference between the first operational data and the second operational data regarding the viscosity and based on the second confidence score. The confidence score module 320 may assign a higher confidence score to the first operational data if there is a large difference between a first value of the viscosity included in the first operational data and a second value of the viscosity included in the second operational data and the second confidence is low than if there is a large difference between the first value of the viscosity included in the first operational data and the second value of the viscosity included in the second operational data and the second confidence score is low.

In some embodiments, the edge agents 302 are configured to ignore the operational data received from another of the edge agents 302 if the confidence score associated with the operational data is below a confidence threshold. For example, if a first of the edge agents 302 is associated with a pump and a second of the edge agents 302 is associated with a valve positioned upstream of the pump, the first of the edge agents 302 may not utilize operational data received from the second of the edge agents 302 associated with the operation of the pump if the confidence score associated with the operational data (e.g., determined by the second of the edge agents 302, etc.) is below the confidence threshold. As a result, the control system 300 may prevent inaccurate operational data from propagating throughout the control system 300 (e.g., from one of the edge agents 302 to another of the edge agents 302, between the edge agents 302, etc.) and/or impacting control decisions generated by the edge agents 302, which may increase an accuracy in the operation of the control system 300 by preventing the edge agents 302 from generating control decisions based on inaccurate operational data.

In some embodiments, the edge agents 302 are configured to change a weight associated with operational data received from another of the edge agents 302 in the control decisions of the edge agents 302 based on the confidence score associated with the operational data. For example, the edge agents 302 may decrease a weight in a control algorithm of the operational data received from another of the edge agents 302 if the confidence score associated with the operational data is below a confidence threshold. For example, a first of the edge agents 302 may be associated with a first pump, a second of the edge agents 302 may be associated with a second pump positioned upstream of the first pump, and a third of the edge agents 302 may be associated with a separator positioned downstream of the first pump and the second pump. The third of the edge agents 302 may weight first operational data received from the first of the edge agents 302 higher than second operational data received from the second of the edge agents 302 when generating control signals for the separator since the first pump is positioned closer to the separator than the second pump. However, if the confidence score associated with the first operational data received from the first of the edge agents 302 is below the confidence threshold, the third of the edge agents 302 may weigh the second operational data received from the second of the edge agents 302 higher than the first operational data when generating the control signals for the separator.

In some embodiments, the confidence score module 320 is configured to generate an alarm based on the confidence score being below the confidence threshold such that an operator associated with the control system 300 may be alerted regarding inaccuracies associated with the operational data corresponding to the confidence score. For example, when the operational confidence score associated with the operational data is below the confidence threshold, the confidence score module 320 may generate a confidence alarm and provide the confidence alarm to at least one of the workstations 208 such that the confidence alarm is provided to an operator associated with the control system 300 (e.g., a user of the at least one of the workstations 208, etc.). The confidence score module 320 may generate the alarm and provide the alarm to the operator such that the operator may adjust operation of the hydrocarbon site 30 to increase the confidence score above the confidence threshold (e.g., by calibrating sensors, by fixing faulty sensors, by decreasing uncertainty, etc.). In some embodiments, the edge agents 302 are configured to automatically adjust the operation of the hydrocarbon site 30 to increase the confidence score above the confidence threshold.

In some embodiments, the confidence score module 320 is configured to generate confidence content associated with the confidence scores for outputting to users. The confidence content can be generated based on the operational data generated by the edge agents 302 and/or the confidence scores associated with the operational data determined by the confidence score module 320. In some embodiments, the confidence score module 320 is configured to provide the confidence content to the workstations 208 to be displayed to users of the workstations 208. For example, the confidence score module 320 may provide real time confidence scores associated with the operational data to the workstations 208 such that the users of the workstations 208 can monitor the confidence scores in real time.

As shown in FIG. 3, the edge agents 302 are configured to run, perform, implement, store, etc., a reputation score module 330 configured to generate a reputation score (e.g., a reputation, a reputation state score, etc.) associated with the operational data provided to the edge agents 302 by at least one other of the edge agents 302 (e.g., a reputation score associated with the other of the edge agents 302, etc.). For example, a first of the edge agents 302 may receive operational data from a second of the edge agents 302. The first of the edge agents 302 may utilize the reputation score module 330 to determine a reputation score associated with the operational data. In some embodiments, the edge agents 302 are configured to receive the operational data from each of the other of the edge agents 302 and the reputation score module 330 is configured to generate a reputation score associated with each of the operational data. The reputation scores may be associated with a reputation that the edge agents 302 have for the operational data received from the other of the edge agents 302. Advantageously, the reputation score determined by the reputation score module 330 can allow for the edge agents 302 to determine a reliability of the operational data received from the other of the edge agents 302. Specifically, the reputation score may allow for each of the edge agents 302 to determine if another of the edge agents 302 of the control system 300 has been compromised (e.g., hacked, failed, etc.) such that the edge agents 302 can know to ignore the operational data and/or the confidence scores received from the other of the edge agents 302 that has been compromised. In some embodiments, the oversight agent 310 is configured to run, perform, implement, store, etc., the reputation score module 330.

In some embodiments, the reputation score module 330 is configured to determine the reputation score for the operational data received from another of the edge agents 302 based on a comparison (e.g., a comparison via modeling, etc.) between the operational data generated by the edge agent 302 and the operational data generated by the other of the edge agents 302. The reputation score module 330 may utilize data-driven models to analyze the operational data generated by the edge agent 302 and the operational data generated by the other of the edge agents 302 in order to determine the reputation score associated with the operational data received from the other of the edge agents 302. For example, a first of the edge agents 302 associated with a first pump may generate first operational data associated with operation of the first pump and a second of the edge agents 302 associated with a second pump positioned upstream of the first pump may generate second operational data associated with operation of the second pump. The first operational data may include a first flow rate of the fluid received by the first pump and the second operational data may include a second flow rate of the fluid output by the second pump. The second of the edge agents 302 may utilize the reputation score module 330 to determine a reputation score for the second operational data based on a comparison of the first flow rate and the second flow rate since the fluid is flowing from the second pump to the first pump. For example, if the second flow rate is similar to the first flow rate (e.g., a difference between the first flow rate and the second flow rate is below a threshold, etc.), the first of the edge agents 302 may generate a high reputation score of the second operational data and if the second flow rate is dissimilar to the first flow rate (e.g., a difference between the first flow rate and the second flow rate is above a threshold, etc.), the first of the edge agents 302 may generate a low reputation score for the second operational data.

In some embodiments, the reputation score module 330 of one of the edge agents 302 is configured to determine the reputation score for the operational data received from another of the edge agents 302 based on the confidence score associated with the operational data generated by the one of the edge agents 302. For example, a first of the edge agents 302 may be associated with operation of a flare and may generate first operational data and confidence data associated with operation of the flare and a second of the edge agents 302 may be associated with operation of a separator that outputs a gas to the flare and may generate second operational data associated with operation of the separator. The first of the edge agents 302 may provide the first operational data, the second operational data, and the confidence score to the reputation score module 330 and the reputation score module 330 may determine a reputation score associated with the second operational data based on a difference between the first operational data and the second operational data and the confidence score. For example, if there is a difference between the first operational data and the second operational data and the confidence score associated with the first operational data is high, the reputation score module 330 may determine that the reputation score associated with the second operational data is lower than if there is a difference between the first operational data and the second operational data and the confidence score associated with the first operational data is low.

In some embodiments, the reputation score module 330 of one of the edge agents 302 is configured to determine the reputation score for the operational data received from another of the edge agents 302 based on the confidence score received from the other of the edge agents 302 associated with the operational data generated by the other of the edge agents 302. For example, if a first of the edge agents 302 receives operational data and an associated confidence score from a second of the edge agents 302, the first of the edge agents 302 may determine a reputation score associated with the operational data based on the confidence score. For example, if the first of the edge agents 302 receives the operational data and a high confidence score from the second of the edge agents 302, the first of the edge agents 302 may determine that the reputation score associated with the operational data is higher than if the first of the edge agents 302 receives the operational data and a low confidence score from the second of the edge agents 302.

In some embodiments, the edge agents 302 are configured to ignore the operational data received from another of the edge agents 302 if the reputation score associated with the operational data is below a reputation threshold. For example, a first of the edge agents 302 may be associated with a first valve and a second of the edge agents 302 may be associated with a second valve positioned upstream of the first valve. The second of the edge agents 302 may provide operational data associated with operation of the second valve to the first of the edge agents 302 and the first of the edge agents 302 may utilize the reputation score module 330 to determine a reputation score associated with the operational data. The first of the edge agents 302 may not utilize the operational data received from the second of the edge agents 302 if the reputation score is below the reputation threshold. As another example, a first of the edge agents 302 may be associated with a first well device and a second of the edge agents 302 may be associated with a second well device. An attacker (e.g., a hacker, a malicious operator, etc.) may compromise (e.g., hack, affect, etc.) the second of the edge agents 302 such that the second of the edge agents 302 provides compromised operational data (e.g., hacked data, inaccurate data, etc.) to the first of the edge agents 302. The first of the edge agent 302 may utilize the reputation score module 330 to determine a reputation score associated with the compromised operational data, and responsive to the reputation score being less than the reputation threshold, the first of the edge agents 302 may ignore the compromised operational data when making control decisions. As a result, the propagation of the operational data provided by the second of the edge agents 302 may be prevented, which may prevent faulty or compromised operational data from influencing the edge agents 302.

In some embodiments, the edge agents 302 are configured to change a weight associated with operational data received from another of the edge agents 302 in the control decisions of the edge agents 302 based on the reputation score associated with operational data. For example, the edge agents 302 may decrease a weight in a control algorithm of the operational data received from another of the edge agents 302 if the reputation score associated with the operational data is below a reputation threshold. For example, a first of the edge agents 302 may be associated with a first well device and a second of the edge agents 302 may be associated with a second well device. The second of the edge agents 302 may provide operational data associated with the operation of the second well device to the first of the edge agents 302. The first of the edge agents 302 may utilize the reputation score module 330 to determine a reputation score associated with the operational data. If the reputation score is below a reputation threshold, the first of the edge agents 302 may decrease a weight associated with the operational data received from the second of the edge agents 302 in a control algorithm of the first of the edge agents 302 such that the operational data has a lower effect on control decisions of the first of the edge agents 302.

In some embodiments, the reputation score module 330 is configured to generate an alarm based on the reputation score being below the reputation threshold such that an operator associated with the control system 300 may be alerted regarding issues associated with the operational data corresponding to the reputation score. For example, when the reputation score associated with the operational data is below the reputation threshold, the reputation score module 330 may generate a reputation alarm and provide the reputation alarm to at least one of the workstations 208 such that the reputation alarm is provided to an operator associated with the control system 300. The reputation score module 330 may generate the alarm and provide the alarm to the operator such that the operator may adjust operation of the hydrocarbon site 30 to increase the reputation score above the reputation threshold (e.g., by calibrating sensors, by fixing faulty sensors, by decreasing uncertainty, by stopping a cyber-attack, etc.). In some embodiments, the edge agents 302 are configured to automatically adjust the operation of the hydrocarbon site 30 to increase the reputation score above the reputation threshold.

In some embodiments, the reputation score module 330 is configured to generate reputation content associated with the reputation scores for outputting to users. The reputation content can be generated based on the operational data generated by the edge agents 302 and/or the reputation scores associated with the operational data determined by the reputation score module 330. In some embodiments, the reputation score module 330 is configured to provide the reputation content to the workstations 208 to be displayed to users of the workstations 208. For example, the reputation score module 330 may provide real time reputation scores associated with the operational data to the workstations 208 such that the users of the workstations 208 can monitor the reputation scores in real time.

In some embodiments, the confidence score module 320 is configured to determine the confidence score associated with the operational data generated by the edge agent 302 based on the operational data received by the edge agent 302 from the other of the edge agents 302 of the control system 300 and corresponding reputation scores generated by the reputation score module 330 associated with the other of the edge agents 302. For example, a first of the edge agents 302 may be associated with a first pump and a second of the edge agents 302 may be associated with a second pump positioned downstream of the first pump. The first of the edge agents 302 may generate first operational data corresponding to operation of the first pump and the second of the edge agents 302 may generate second operational data corresponding to operation of the second pump and provide the second operational data to the first of the edge agents 302. The first of the edge agents 302 may utilize the reputation score module 330 to determine a reputation score associated with the second operational data and then may utilize the confidence score module 320 to determine a confidence score associated with the first operational data based on a comparison between the first operational data and the second operational data and the reputation score associated with the second operational data. For example, if a flow of fluid flows through the first pump and the second pump with a temperature, the confidence score module 320 may determine a lower confidences score for the first operational data if there is a difference between the temperatures in the first operational data and the second operational data and the reputation score associated with the second operational data is lower than if the reputation score associated with the second operational data is higher.

As shown in FIG. 3, the oversight agent 310 is configured to run, perform, implement, store, etc., a validation score module 340 configured to generate a validation score (e.g., a validation, a validation state score, etc.) associated with the operational data provided by the edge agents 302 to the oversight agent 310 (e.g., associated with the edge agents 302, etc.). For example, one of the edge agents 302 associated with a well device may generate operational data associated with operation of the well device and provide the operational data to the oversight agent 310. The oversight agent 310 may utilize the validation score module 340 to determine a validation score associated with the operational data. In some embodiments, the validation score module 340 is configured to determine the validation score associated with operational data received from one of the edge agents 302 based on operational data received from each of the edge agents 302. In other embodiments, the validation score module 340 is configured to determine the validation score associated with operational data received from one of the edge agents 302 based on the operational data received from the one of the edge agents 302. In various embodiments, the control system 300 does not include the oversight agent 310, and, instead at least one of the edge agents 302 (e.g., a primary edge agent, an oversight edge agent, etc.) is configured to run, perform, implement, store, etc., the validation score module 340.

In some embodiments, the oversight agent 310 provides the validation scores to the edge agents 302 of the control system 300. For example, a first of the edge agents 302 may provide operational data to the oversight agent 310. The oversight agent 310 may utilize the validation score module 340 to determine a validation score associated with the operational data and provide the validation score to a second of the edge agents 302 and a third of the edge agents 302. In some embodiments, the oversight agent 310 provides the operational data received from one of the edge agents 302 to the other of the edge agents 302 of the control system 300.

In some embodiments, the validation score module 340 is configured to determine the validation score associated with operational data utilizing modeling and/or other analysis techniques. For example, the validation score module 340 may utilize a physics-based model (e.g., data driven models, global level models, system level models, etc.) of the hydrocarbon site 30 to determine the validation scores associated with the operational data. By implementing the modeling on the validation score module 340 through the oversight agent 310, the complex modeling may be performed away from the edge agents 302, which may not include sufficient processing power to perform the complex modeling. The validation score module 340 may receive operational data from various of the edge agents 302 of the control system 300 and enter the operational data into system models (e.g., computerized models, software models, modules of the hydrocarbon site 30, etc.) to determine the validation scores associated with the operational data received from each of the edge agents 302. For example, the oversight agent 310 may receive first operational data from a first of the edge agents 302 associated with operation of the hydrocarbon site 30, second operational data from a second of the edge agents 302 associated with the operation of the hydrocarbon site 30, and third operational data from a third of the edge agents 302 associated with the operation of the hydrocarbon site 30. The oversight agent 310 may provide the first operational data, the second operational data, and the third operational data to the validation score module 340, which may utilize a model of the hydrocarbon site 30 to determine a first validation score associated with the first operational data, a second validation score associated with the second operational data, and a third validation score associated with the third operational data. The validation score module 340 may utilize the model to determine if the operational data fits in a context of (e.g., makes sense within, etc.) the operation of the hydrocarbon site 30 in order to determine each of the validation scores. For example, if the model of the hydrocarbon site 30 indicates that the first operational data and the third operational data fit into the operation of the hydrocarbon site 30, but the second operational data does not fit into the operation of the hydrocarbon site 30, the validation score module 340 may determine higher validation scores for the first operational data and the third operational data than the second operational data.

In some embodiments, the validation score module 340 is configured to determine the validation score for operational data received from one of the edge agents 302 based on a confidence score received from the one of the edge agents 302 associated with the operational data. For example, the validation score module 340 may assign a higher validation score to the operational data if the confidence score associated with the operational data is higher than if the confidence score is lower. As another example, the validation score module 340 may assign a lower validation score to the operational data if the confidence score associated with the operational data is lower than if the confidence score is higher even if the validation score module 340 determines that the operational data is accurate due to the confidence score indicating that the edge agent 302 is not properly determining the confidence score. In some embodiments, the validation score module 340 is configured to determine the validation score for operational data received from one of the edge agents 302 based on confidence scores received from each of the edge agents 302 of the control system 300.

In some embodiments, the validation score module 340 is configured to determine the validation score for operational date received from one of the edge agents 302 based on a reputation score received from another of the edge agents 302 associated with the operational data received from the one of the edge agents 302. For example, the oversight agent 310 may receive operational data from a first of the edge agents 302 and a reputation score associated with the operational data from a second of the edge agents 302 (e.g., a reputation score determined by the reputation score module 330 of the second of the edge agents 302, etc.). The oversight agent 310 may utilize the validation score module 340 to determine a validation score associated with the operational data based on the reputation score. For example, the validation score module 340 may determine a higher validation score for the operational data if the reputation score is higher than if the reputation score is lower. In some embodiments, the validation score module 340 is configured to determine the validation score for operational data received from one of the edge agents 302 based on reputation scores received from each of the edge agents 302 of the control system 300.

In some embodiments, the oversight agent 310 may determine whether to utilize the validation score module 340 to determine the validation scores associated with operational data (e.g., perform oversight analysis, run a validation test, etc.) based on the confidence scores and the reputation scores associated with the operational data that are received from the edge agents 302. For example, the oversight agent 310 may utilize the validation score module 340 to determine the validation scores associated with the operational data received from the edge agents 302 based on at least one of the confidence scores associated with the operational data being below a confidence threshold. As another example, the oversight agent 310 may utilize the validation score module 340 to determine the validation scores associated with the operational data received from the edge agents 302 based on at least one of the reputation scores associated with the operational data being below a reputation threshold. As a result, the oversight agent 310 may utilize the validation score module 340 when there is uncertainty in the control system 300 (e.g., when at least one of the confidence scores is below the confidence threshold, when at least one of the reputation scores is below the reputation threshold, etc.) in order to validate the operational data such that the uncertainty can be removed from the control system 300.

In some embodiments, the oversight agent 310 is configured to distribute the validation scores associated with the operational data when the validation scores are below a validation threshold. For example, a first of the edge agents 302 may provide first operational data to the oversight agent 310 and a second of the edge agents 302 may provide second operational data to the oversight agent 310. The oversight agent 310 may utilize the validation score module 340 to determine a first validation score associated with the first operational data and a second validation score associated with the second operational data. The oversight agent 310 may distribute the first validation score to the edge agents 302 of the control system 300 responsive to the first validation score being below a validation threshold and may not distribute the second validation score to the edge agents 302 responsive to the second validation score being above the validation threshold, such that the edge agents 302 may be made aware of the first validation score being below the validation threshold. As a result, the edge agents 302 may be made aware that the first operational data received from the first of the edge agents 302 should not be trusted and/or used by the other of the edge agents 302 while generating control decisions. In various embodiments, the oversight agent 310 is configured to distribute the validation scores associated with the operational data when the validation scores are above a validation threshold. As a result, the edge agents 302 may be made aware of the operational data that should be trusted and/or used by the edge agents 302 while generating control decisions.

In some embodiments, the oversight agent 310 is configured to run an oversight analysis (e.g., utilize the validation score module 340 to generate the validation scores, etc.) based on a schedule (e.g., daily, monthly, etc.). In some embodiments, the oversight agent 310 may skip at least one occurrence of the oversight analysis based on the confidence scores and/or the reputation scores received from the edge agents 302. For example, the oversight agent 310 may skip an occurrence of the oversight analysis in response to each of the confidence scores associated with the operational data received from the edge agents 302 being above a confidence threshold. As another example, the oversight agent 310 may skip an occurrence of the oversight analysis in response to each of the reputation scores associated with the operational data received from the edge agents 302 being above a reputation threshold. By skipping occurrences of the oversight analysis, an amount of processing performed by the oversight agent 310 may be reduced, freeing the oversight agent 310 to perform other tasks.

In some embodiments, the oversight agent 310 is configured to generate corrected operational data in response to the validation scores associated with the operational data being below a validation threshold. The oversight agent 310 may generate the corrected operational data utilizing models of the hydrocarbon site 30 and/or the operational data received from the edge agents 302. For example, the oversight agent 310 may receive first operational data from a first of the edge agents 302, second operational data from a second of the edge agents 302, and third operational data from a third of the edge agents 302. The oversight agent 310 may utilize the validation score module 340 to determine a first validation score associated with the first operational data, a second validation score associated with the second operational data, and a third validation score associated with the third operational data. Responsive to the second validation score being less than a validation threshold, the oversight agent 310 may generate corrected second operational data (e.g., based on the first operational data and the third operational data, etc.) and distribute the corrected second operational data to the first of the edge agents 302 and the third of the edge agents 302 such that the first of the edge agents 302 and the third of the edge agents 302 may utilize the corrected second operational data instead of the second operational data when generating control decisions.

In some embodiments, the validation score module 340 is configured to generate an alarm based on the validation score being below the validation threshold such that an operator associated with the control system 300 may be alerted regarding inaccuracies associated with the operational data corresponding to the validation scores. For example, when the validation score associated with the operational data is below the validation threshold, the validation score module 340 may generate a validation alarm and provide the validation alarm to at least one of the workstations 208 such that the validation alarm is provided to an operator associated with the control system 300 (e.g., a user of the at least one of the workstations 208, etc.). The validation score module 340 may generate the alarm and provide the alarm to the operator such that the operator may adjust operation of the hydrocarbon site 30 in order to increase the validation score above the validation threshold. In some embodiments, the oversight agent 310 and/or the edge agents 302 are configured to automatically adjust the operation of the hydrocarbon site 30 to increase the validation score above the validation threshold.

In some embodiments, the validation score module 340 is configured to generate validation content associated with the validation scores for outputting to users. The validation content can be generated based on the operational data received by the oversight agent 310 (e.g., provided by the edge agents 302, etc.) and/or the validation scores associated with the operational data determined by the validation score module 340. In some embodiments, the validation score module 340 is configured to provide the validation content to the workstations 208 to be displayed to users of the workstations 208. For example, the validation score module 340 may provide real time validation scores associated with the operational data to the workstations such that the users of the workstations 208 can monitor the confidences scores in real time.

In some embodiments, the oversight agent 310 is configured to limit communication between one of the edge agents 302 and other of the edge agents 302 based on the validation score associated with the operational data received from the one of the edge agents 302 being below a validation threshold. For example, the oversight agent 310 may receive operational data from a first of the edge agents 302. The oversight agent 310 may utilize the validation score module 340 to determine a validation score associated with the operational data. Responsive to the validation score being below a validation threshold, the oversight agent 310 may provide a control signal to a second of the edge agents 302 and a third of the edge agents 302 to ignore data received from the first of the edge agents 302. As a result, the second of the edge agents 302 and the third of the edge agents 302 may be prevented from being contaminated (e.g., affected, etc.) by the operational data provided by the first of the edge agents 302.

In some embodiments, the oversight agent 310 is configured to shut down (e.g., turn off, etc.) one of the edge agents 302 based on the validation score associated with the operational data received from the one of the edge agents 302 being below a validation threshold. For example, the oversight agent 310 may receive operational data from one of the edge agents 302. The oversight agent 310 may utilize the validation score module 340 to determine a validation score associated with the operational data. Responsive to the validation score being below a validation threshold, the oversight agent 310 may provide a control signal to the one of the edge agents 302 to shut down to prevent the one of the edge agents 302 from generating additional operational data.

In some embodiments, the edge agents 302 are configured to ignore the operational data received from another of the edge agents 302 when the edge agents 302 receive a validation score (e.g., from the oversight agent 310, etc.) associated with the operational score that is below a validation threshold. As a result, the propagation of the operational data provided by the edge agents 302 may be prevented when the validation score associated with the operational data is less than the validation threshold, which may prevent faulty or compromised operational data from influencing the edge agents 302.

In some embodiments, the edge agents 302 are configured to change a weight associated with operational data received from another of the edge agents 302 based on the edge agents 302 receiving a validation score associated with the operational data that is below a validation threshold. For example, the edge agents 302 may decrease a weight in a control algorithm of the operational data received from another of the edge agents 302 when the edge agents 302 receive a validation score associated with the operational data from the oversight agent 310 that is below the validation threshold. As a result, operational data provided by the edge agents 302 associated with validation scores that are less than validation thresholds may have a lower effect on control decisions of the edge agents 302 than operational data provided by the edge agents 302 associated with validation scores that are greater than validation thresholds.

### Method for Determining Confidence Score

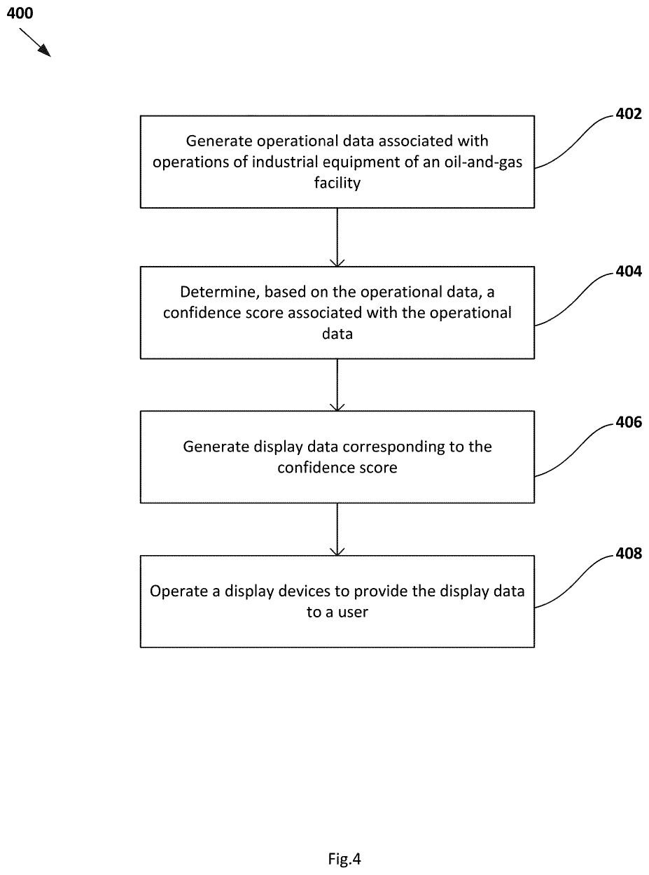

Referring now to FIG. 4, a flow process diagram of a process 400 for determining and displaying a confidence score associated with operational data is shown, according to some embodiments. Process 400 includes steps 402-408 and can be performed by the cloud-based computing system 12, the RTU 26, the control system 300, and/or the edge agent 302, according to some embodiments. In some embodiments, process 400 includes determining the confidence score associated with the operational data corresponding to operations of industrial equipment of an oil-and-gas facility (e.g., the hydrocarbon site 30, etc.). In other embodiments, the process 400 includes determining the confidence score associated with the operational data corresponding to operations of industrial equipment of other industrial sites (e.g., refineries, power plants, etc.).

Process 400 includes generating operational data associated with operations of industrial equipment of an oil-and-gas facility (step 402), according to some embodiments. In some embodiments, the operational data is generated based on sensor data obtained from a sensing unit associated with the industrial equipment. In some embodiments, step 402 is performed by one of the edge agents 302 of the control system 300. For example, the one of the edge agents 302 may obtain sensor data associated with operations of industrial equipment of the hydrocarbon site 30 and generate the operational data based on the sensor data. In other embodiments, step 402 is performed by the oversight agent 310.

Process 400 includes determining, based on the operational data, a confidence score associated with the operational data (step 404), according to some embodiments. The confidence score may represent an amount of uncertainty associated with the operational data generated during step 402. In some embodiments, step 404 is performed by one of the edge agents 302 of the control system 300 (e.g., the same of the edge agents 302 that performed the step 402, etc.). For example, the one of the edge agents 302 may utilize the confidence score module 320 to determine the confidence score associated with the operational data generated during step 402. In other embodiments, step 404 is performed by the oversight agent 310. For example, the oversight agent 310 may receive the operational data generated during step 402 and utilize the confidence score module 320 to determine the confidence score associated with the operational data generated during step 402.

Process 400 includes generating display data corresponding to the confidence score (step 406), according to some embodiments. The display data may include the operational data generated during step 402. In some embodiments, the confidence score module 320 generates the display data corresponding to the confidence score. For example, the confidence score module 320 may generate the display data corresponding to the confidence score after being utilized to determine the confidence score associated with the operational data in step 404. In other embodiments, another control element may generate the display data (e.g., the cloud-based computing system 12, etc.).

Process 400 includes operating a display device to provide the display data to a user (step 408) according to some embodiments. In some embodiments, step 408 is performed by the control system 300 by providing the display data generated during step 406 to at least one of the workstations 208 such that the user is provided with the display data.

### Method for Determining Reputation Score

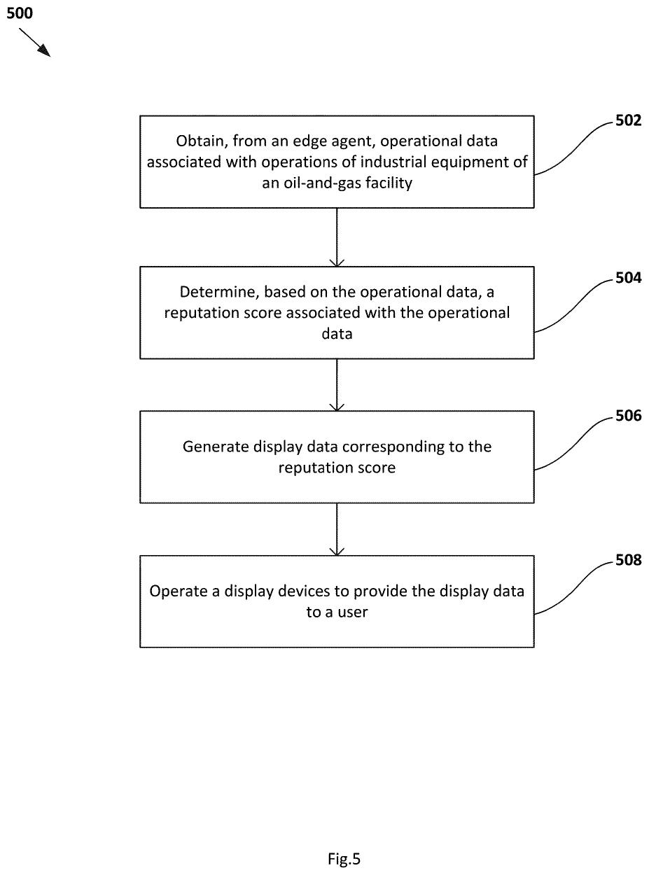

Referring now to FIG. 5, a flow process diagram of a process 500 for determining and displaying a reputation score associated with operational data is shown, according to some embodiments. Process 500 includes steps 502-508 and can be performed by the cloud-based computing system 12, the RTU 26, the control system 300, and/or the edge agent 302, according to some embodiments. In some embodiments, process 500 includes determining the reputation score associated with the operational data corresponding to operations of industrial equipment of an oil-and-gas facility (e.g., the hydrocarbon site 30, etc.). In other embodiments, the process 500 includes determining the reputation score associated with the operational data corresponding to operations of industrial equipment of other industrial sites (e.g., refineries, power plants, etc.).

Process 500 includes obtaining, from an edge agent, operational data associated with operations of industrial equipment of an oil-and-gas facility (step 502), according to some embodiments. In some embodiments, the operational data is received from an edge agent associated with the industrial equipment and configured to generate the operational data associated with the edge equipment. In some embodiments, step 502 is performed by one of the edge agents 302 that receives the operational data from another of the edge agents 302. In other embodiments, step 502 is performed by the oversight agent 310 that receives the operational data from one of the edge agents 302.

Process 500 includes determining, based on the operational data, a reputation score associated with the operational data (step 504), according to some embodiments. The reputation score may represent a reputation of the operational data received from the edge agent and/or a reputation associated with the edge agent. For example, a high reputation score may indicate a high level of trust in the operational data and/or the edge agent and a low reputation score may indicate a low level of trust in the operational data and/or the edge agent. In some embodiments, step 504 is performed by one of the edge agents 302 of the control system 300 (e.g., the same of the edge agents 302 that performed step 502, etc.). For example, the one of the edge agents 302 may utilize the reputation score module 330 to determine the reputation score associated with the operational data received during step 502. In other embodiments, step 504 is performed by the oversight agent 310. For example, the oversight agent 310 may utilize the reputation score module 330 to determine the reputation score associated with the operational data received during step 502.

Process 500 includes generating display data corresponding to the reputation score (step 506), according to some embodiments. The display data may include the operational data received during step 502. In some embodiments, the reputation score module 330 generates the display data corresponding to the reputation score. For example, the reputation score module 330 may generate the display data corresponding to the reputation score after being utilized to determine the reputation score associated with the operational data in step 504. In other embodiments, another control element may generate the display data (e.g., the cloud-based computing system 12, etc.).

Process 500 includes operating a display device to provide the display data to a user (step 508) according to some embodiments. In some embodiments, step 508 is performed by the control system 300 by providing the display data generated during step 506 to at least one of the workstations 208 such that the user is provided with the display data.

### Method for Determining Validation Score

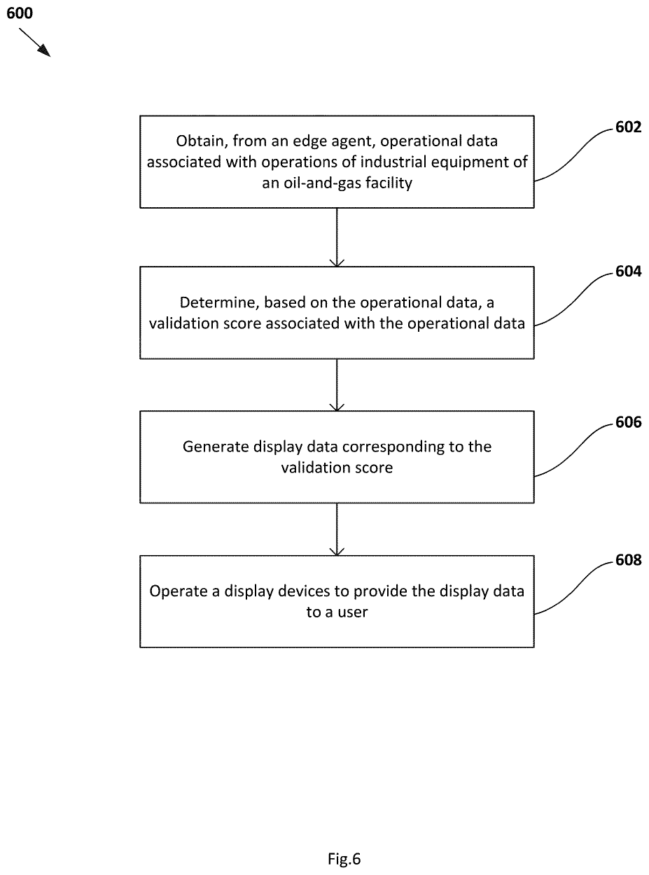

Referring now to FIG. 6, a flow process diagram of a process 600 for determining and displaying a validation score associated with operational data is shown, according to some embodiments. Process 600 includes steps 602-608 and can be performed by the cloud-based computing system 12, the RTU 26, the control system 300, and/or the oversight agent 310, according to some embodiments. In some embodiments, process 600 includes determining the validation score associated with the operational data corresponding to operations of industrial equipment of an oil-and-gas facility (e.g., the hydrocarbon site 30, etc.). In other embodiments, the process 600 includes determining the validation score associated with the operational data corresponding to operations of industrial equipment of other industrial sites (e.g., refineries, power plants, etc.).

Process 600 acquiring, from an edge agent, operational data associated with operations of industrial equipment of an oil-and-gas facility (step 602), according to some embodiments. In some embodiments, the operational data is received from an edge agent associated with the industrial equipment and configured to generate the operational data associated with the edge equipment. In some embodiments, step 602 is performed by the oversight agent 310 that receives the operational data from one of the edge agents 302. In other embodiments, step 602 is performed by one of the edge agents 302 that receives the operational data from another of the edge agents 302.

Process 600 includes determining, based on the operational data, a validation score associated with the operational data (step 604), according to some embodiments. The validation score may represent a validity of the operational data received from the edge agent based on analyzing the operational data using data-based modeling. For example, a high validation score may indicate that the operational data aligns with results of the data-based modeling and a low validation score may indicate that the operational data does not align with results of the data-based modeling. In some embodiments, step 604 is performed by the oversight agent 310. For example, the oversight agent 310 may utilize the validation score module 340 to determine the validation score associated with the operational data received during step 602. In other embodiments, step 604 is performed by one of the edge agents 302. For example, the one of the edge agents 302 may utilize the validation score module 340 to determine the validation score associated with the operational data received during step 602.

Process 600 includes generating display data corresponding to the validation score (step 606), according to some embodiments. The display data may include the operational data received during step 602. In some embodiments, the validation score module 340 generates the display data corresponding to the validation score. For example, the validation score module 340 may generate the display data corresponding to the validation score after being utilized to determine the validation score associated with the operational data in step 604. In other embodiments, another control element may generate the display data (e.g., the cloud-based computing system 12, etc.).

Process 600 includes operating a display device to provide the display data to a user (step 608) according to some embodiments. In some embodiments, step 608 is performed by the control system 300 by providing the display data generated during step 606 to at least one of the workstations 208 such that the user is provided with the display data.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of various systems and methods as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A system, comprising:
industrial equipment providing operations of an oil or gas facility; and
a control system for the oil or gas facility, the control system comprising:
a first edge agent configured to generate operational data associated with operation of the industrial equipment,
a second edge agent configured to acquire the operational data from the first edge agent, the second edge agent configured to generate, based on the operational data, and provide control decisions to the industrial equipment, and
an oversight device configured to:
acquire the operational data from the first edge agent;
determine, based on the operational data, a validation score associated with the operational data; and
responsive to the validation score being less than a validation threshold, prevent the second edge agent from acquiring the operational data.

2. The system of claim 1, wherein the oversight device comprises an oversight agent.

3. The system of claim 2, wherein the oversight agent is executed in a cloud computing system.

4. The system of claim 3, wherein the oversight agent is communicably coupled to each of the first edge agent and the second edge agent through a secure handshake.

5. The system of claim 1, wherein the oversight device is configured to execute a complex validation model.

6. The system of claim 1, wherein the oversight device is configured to receive a confidence score from the first edge agent and assign the validation score using the confidence score.

7. The system of claim 1, wherein the oversight device is configured to receive a first confidence score from the first edge agent and a second confidence score from the second edge agent and assign the validation score using the first confidence score and the second confidence score.

8. The system of claim 7, wherein the oversight device is configured to receive a reputation score from the first edge agent and assign the validation score using the reputation score, wherein the reputation score represents a reputation associated with the first edge agent or data from the first edge agent.

9. The system of claim 1, wherein the oversight device is configured to:
acquire an uncertainty score associated with the operational data; and
responsive to the uncertainty score determine the validation score.

10. The system of claim 1, wherein the oversight device is configured to:
acquire a reputation score associated with the operational data; and
responsive to the reputation score determine the validation score.

11. A method of operating equipment providing operations of an oil or gas facility, the method comprising:
generating operational data using a first edge agent associated with operation of the equipment;
acquiring the operational data from the first edge agent by a second edge agent;
generating by the second edge agent, in response to the operational data, control decisions to the industrial equipment,
acquiring the operational data from the first edge agent by an oversight device;
determining, based on the operational data, a validation score associated with the operational data using the oversight device; and
responsive to the validation score being less than a validation threshold, preventing the second edge agent from acquiring the operational data.

12. The method of claim 11, wherein the oversight device comprises an oversight agent.

13. The method of claim 12, wherein the oversight agent is executed in a cloud computing system.

14. The method of claim 13, wherein the oversight agent is communicably coupled to each of the first edge agent and the second edge agent through a secure handshake.

15. The method of claim 11, wherein the oversight device is configured to execute a complex validation model.

16. The method of claim 11, wherein the oversight device is configured to receive a confidence score from the first edge agent and assign the validation score using the confidence score.

17. The method of claim 11, wherein the oversight device is configured to receive a first confidence score from the first edge agent and a second confidence score from the second edge agent and assign the validation score using the first confidence score and the second confidence score.

18. A system for equipment providing operations of an oil or gas facility, the system comprising:
a first agent configured to generate operational data associated with operation of the equipment,
a second agent configured to acquire the operational data from the first agent, the second agent configured to generate, based on the operational data, and provide control decisions to the equipment; and
an oversight device configured to:
acquire the operational data from the first agent;
determine, based on the operational data, a validation score associated with the operational data; and
responsive to the validation score being less than a validation threshold, prevent the second agent from acquiring the operational data.

19. The system of claim 18, wherein the oversight device is configured to receive a first confidence score from the first agent and a second confidence score from the second agent and assign the validation score using the first confidence score and the second confidence score.

20. The system of claim 19, wherein the reputation score represents a reputation associated with the first agent or data from the first agent.
